(19) United States
(12) Patent Application Publication
(10) Pub. No.: US 2002/0075350 A1
(43) Pub. Date: Jun. 20, 2002

(54) Ink jet printer having a cleaning blade cleaner assembly

(75) Inventor: Paul F. Sawicki, Rochester, NY (US)

Correspondence Address: John E. Beck, Xerox Corporation, Xerox Square 20A, Rochester, NY, 14644, US

(73) Assignee: Xerox Corporation

(21) Appl. No.: 09/738,729

(22) Filed: Dec. 15, 2000

(51) Int. Cl. B41J 2/165

(52) U.S. Cl. 347/33; 347/36

(57) ABSTRACT

A cleaning blade cleaner assembly is provided for contacting, scraping, wiping and wicking residual liquid ink from a printhead cleaning blade immediately after the printhead cleaning blade has wiped and cleaned an ink jet printhead within an ink jet printer. The cleaning blade cleaner assembly includes a support frame and a rigid scraping member mounted to the support frame. The rigid scraping member has a body portion, and a scraping edge adjoining the body portion for making scraping and wiping contact with printhead cleaning blade during relative motion between the printhead cleaning blade and the rigid scraping member. The cleaning blade cleaner assembly also includes a liquid ink wicking and absorbing member attached to the body portion of the rigid scraping member for immediately and quickly wicking and absorbing liquid ink scraped and wiped from the printhead cleaning blade immediately after the printhead cleaning blade has wiped and cleaned an ink jet printhead within the ink jet printer, thereby resulting in continued high quality printed images, and in a relatively longer printhead life.

### RELATED APPLICATION

This application is related to U.S. application Ser. No. ______ (Applicants' Docket NO. D/A0963) entitled “INK JET PRINTER HAVING A FAST ACTING MAINTENANCE ASSEMBLY” filed on the same date herewith, and having at least one common inventor.

### BACKGROUND OF THE INVENTION

The present invention relates generally to printers such as ink jet printers, and more particularly to such a printer having ink jet printheads and a cleaning blade cleaner assembly that quickly and immediately scrapes, wipes, wicks and blots residual liquid ink from a flexible elastomeric printhead cleaning or wiping blade immediately after such blade has wiped and cleaned the ink jet printhead.

An ink jet printer of the type frequently referred to as drop-on-demand, has at least one printhead from which droplets of ink are directed towards a recording medium. Within the printhead, the ink is contained in a plurality of channels. Piezoelectric devices or power pulses cause the droplets of ink to be expelled as required, from orifices or nozzles located at the end of the channels. In thermal ink jet printing, the power pulses are usually produced by resistors also known as heaters, each located in a respective one of the channels. The heaters are individually addressable to heat and vaporize the ink in the channels. As a voltage is applied across a selected heater, a vapor bubble grows in that particular channel and ink bulges from the channel nozzle. At that stage, the bubble begins to collapse. The ink within the channel retracts and then separates from the bulging ink thereby forming a droplet moving in a direction away from the channel nozzle and towards the recording medium whereupon hitting the recording medium a spot is formed. The channel is then refilled by capillary action which, in turn, draws ink from a supply container of liquid ink.

The ink jet printhead may be incorporated into either a carriage type printer or a page width type printer. The carriage type printer typically has a relatively small printhead containing the ink channels and nozzles. The printhead is usually sealingly attached to a disposable ink supply cartridge and the combined printhead and cartridge assembly is attached to a carriage which is reciprocated to print one swath of information (equal to the length of a column of nozzles) at a time on a stationary recording medium, such as a sheet of paper or a transparency.

After each such swath is printed, the sheet of paper is transported or advanced forwardly (usually the movement involves stepping or indexing) a distance that is equal to the height of the printed swath or of a portion thereof so that the next printed swath is properly registered in an overlapping or contiguous manner therewith.

As is well known, in order to provide printhead long life, and to ensure continued high quality printing, ink jet printers usually include some type of a printhead maintenance assembly intended to clean the nozzles and prevent liquid ink from drying up and clogging such nozzles. Conventionally, such maintenance assemblies include a wiping only device and a capping device. Unfortunately, depending on the unpredictable amount of ink left on the printhead, excessive ink may build up on the wiping or cleaning blade or blades. When this excessive ink builds up on the blade or blades, poor wiping results initially. Moreover, if this excessive ink is allowed to dry on the blades, it becomes a viscous sludge which will smear over, and clog the nozzles. The undesirable result is poor quality prints for a while, and a reduced life for the entire printhead.

There is therefore a need for a cleaning blade cleaner assembly that quickly and immediately scrapes, wipes, wicks and blots residual liquid ink from the flexible, elastomeric wiper or cleaning blades, immediately after such blades have wiped and cleaned the ink jet printheads so as to assure continued high quality printed images and a relatively longer printhead life.

### SUMMARY OF THE INVENTION

In accordance with the present invention, there has been provided a cleaning blade cleaner assembly that is mountable oppositely to, and in an interfering relationship with, a moveable printhead cleaning blade in an ink jet printer for contacting, scraping, wiping and wicking residual liquid ink from the moveable printhead cleaning blade immediately after the moveable printhead cleaning blade has wiped and cleaned an ink jet printhead within the ink jet printer. The cleaning blade cleaner assembly includes a support frame and a rigid scraping member mounted to the support frame. The rigid scraping member has a body portion, and a scraping edge adjoining the body portion for making scraping and wiping contact with moveable printhead cleaning blade during relative motion between the moveable printhead cleaning blade and the rigid scraping member. The cleaning blade cleaner assembly also includes a liquid ink wicking and absorbing member attached to the body portion of the rigid scraping member for immediately and quickly wicking and absorbing liquid ink scraped and wiped from the moveable printhead cleaning blade immediately after the moveable printhead cleaning blade has wiped and cleaned an ink jet printhead within the ink jet printer, thereby resulting in continued high quality printed images, and in a relatively longer printhead life.

### BRIEF DESCRIPTION OF THE DRAWINGS

In the detailed description of the invention presented below, reference is made to the drawings, in which:

FIG. 1 is a schematic illustration of a liquid ink printer including the cleaning blade cleaner assembly in accordance with the present invention;

FIG. 2 is an enlarged illustration of a first embodiment of the cleaning blade cleaner assembly of the present invention; and

FIG. 3 is an enlarged illustration of a second embodiment of the cleaning blade cleaner assembly of the present invention.

### DETAILED DESCRIPTION OF THE INVENTION

While the present invention will be described in connection with a preferred embodiment thereof, it will be understood that it is not intended to limit the invention to that embodiment. On the contrary, it is intended to cover all alternatives, modifications, and equivalents as may be included within the spirit and scope of the invention as defined by the appended claims.

Although the present invention discussed herein may be used for drying any image which is created by a liquid ink printer, the description of the present invention will be described in the environment of an ink jet printer such as that shown in the drawings.

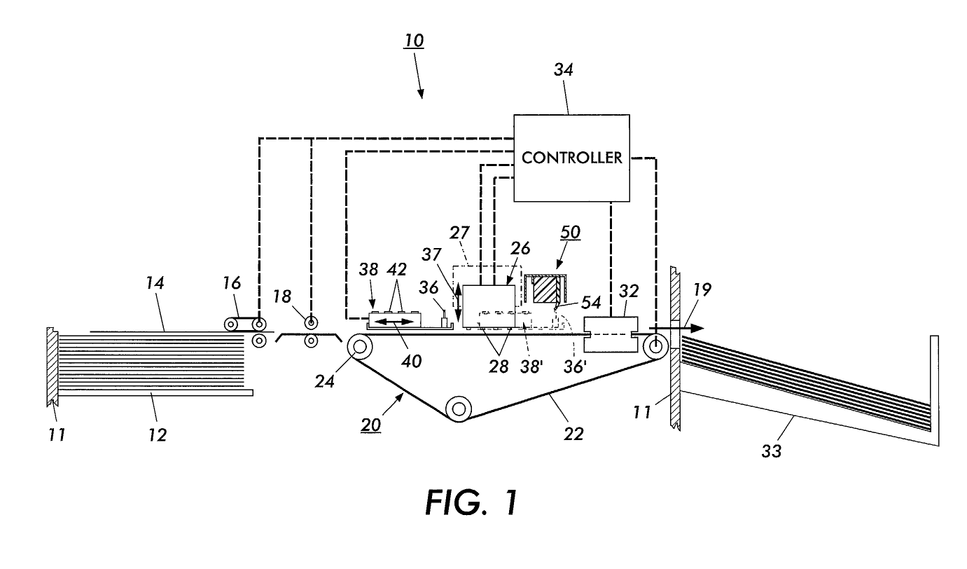

Referring now to FIG. 1, it illustrates a schematic elevational view of a liquid ink printer 10, for instance, an ink jet printer, of the present invention. The liquid ink printer 10 includes a frame 11 (shown partially) and an input tray 12 containing sheets of a recording medium 14 to be printed upon by the printer 10. Single sheets of the recording medium 14 are removed from the input tray 12 by a pickup device 16 and fed by feed rollers 18 to a transport mechanism 20. The transport mechanism 20 moves the sheet in the direction of the arrow 19, and by means of a feed belt or belts 22 driven by rollers 24 beneath a liquid ink printhead assembly 26 including at least a printhead 28 for printing ink images on the sheet or recording medium 14.

The printhead assembly 26 may include one or more pagewidth array printheads 28, that are each connected to a liquid ink supply 27, and are supported in a printing position by a printhead support (not shown) in a confronting or opposite relation with the belt 22. During printing, the printheads 28 deposit liquid ink on the recording medium 14 as it is carried by rollers, 22 passed beneath such printheads 28. Each of the printheads 28 includes an array of print nozzles, for instance, staggered or linear arrays, having a length sufficient to deposit ink in a print zone across the width of the recording medium 14. The recording medium 14 may then carried by the rollers 22 through a dryer assembly 32, from which it is unloaded into an output tray 33.

A controller 34 controls the operation of the transport mechanism 20, which includes the pickup device 16, the feed roller 18, the drive roller 24 and rollers 22. In addition, the controller 34 controls the movement of the printhead assembly 26, printing by the printheads 28, and maintenance of the printheads 28 using a cleaning blade 36 and capping assembly 38. As shown, the cleaning blade 36 is then cleaned by the cleaning blade cleaner assembly 50 in accordance with the present invention (to be described in detail below). The controller 34 can also include a plurality of individual controllers, such as microprocessors or other known devices dedicated to perform a particular function.

At the completion of a printing operation or when otherwise necessary, such as during a power failure, the printhead assembly 26, which is movable in the directions of an arrow 37, is moved away from the printing zone for maintenance by cleaning blade 36 and by capping assembly 38. As illustrated, the cleaning blade 36 and capping assembly 38 are moveable in the direction of the arrow 40 to at least phantom positions 38′ and 36′ as shown. The cleaning blade 36′ and capping assembly 38′ are moved thus such that the cleaning blade 36′ is passed the cleaning blade cleaner assembly 50 of the present invention. As such the cleaning blade cleaner assembly 50 effectively and immediately contacts, scrapes, wipes and cleans a front surface of the blade 36. As shown, the cleaning blade 36′ and capping assembly 38′ then have to move back, slightly and some distance, in order to align the nozzles of the printheads 28 with the capping gaskets 42 of capping assembly 38′. During such slight backward movement, the back side of the blade 36′ also contacts the cleaning blade cleaner assembly 50 so that it to is effectively and immediately scraped, wiped and cleaned. Once the capping assembly 38′ is positioned directly beneath the printhead assembly 26, the printhead assembly 26 is moved down so that the printheads 28 come into contact with the plurality of capping gaskets 42 located on the capping assembly 38.

Referring now to FIGS. 1-3, the wiping or cleaning blade 36, as disclosed above, is moveable in the direction of the arrow 40 in order to create relative motion between the cleaning blade cleaner assembly 50, and the printheads 28. As shown, the cleaning blade cleaner assembly 50 includes a rigid scraping member 54 that is mounted to a support frame 56. The scrapping member 54 is a rigid, injection molded plastic cantilevered member with an extending distal end thereto as shown. The rigid scraping member 54 has a body portion 58, and a scraping edge 60 adjoining the body portion for making scraping and wiping contact with the wiping blades(s) during relative motion between such wiping or cleaning blade 36, and the rigid scraping member 54. The rigid scraping member 54 has a first surface 62 and a second and opposite surface 64 as shown, and as shown, the scrapping edge 60 is angled to the first side or surface 62 of the body portion 58, and includes a gentle taper or chamfer 65 on the second and opposite side or surface 64. The gentle chamfer 65 allows the distal end of the wiper or cleaning blade 36 to be cleaned effectively, and to pass more easily under scraping edge of the cleaning blade cleaner assembly 50.

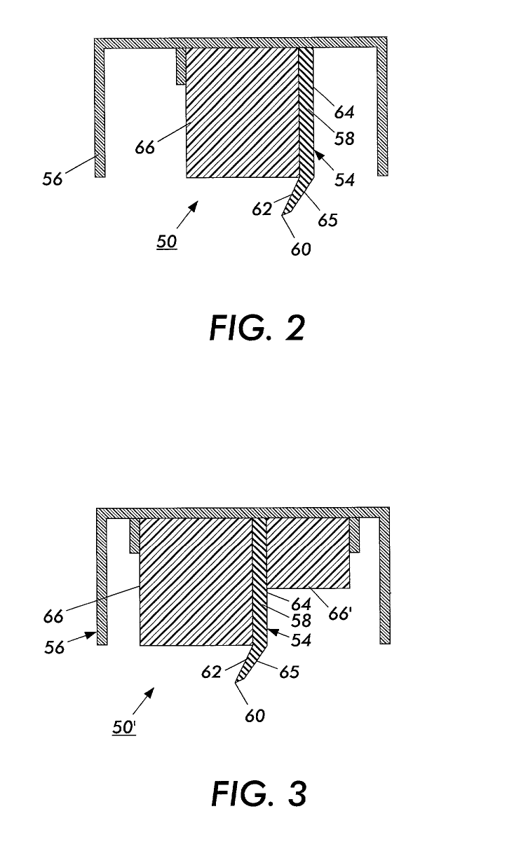

The cleaning blade cleaner assembly 50, 50′ also includes a liquid wicking and absorbing member 66, 66′ that is attached to at least one of the first and the second surfaces 62, 64 of the body portion 58 as shown in FIGS. 2 and 3. In FIG. 2, a first embodiment 50 is shown in which the liquid wicking and absorbing member 66 is attached only to the first surface 62, whereas in FIG. 3 a second embodiment 50′ has liquid ink wicking and absorbing members 66, 66′ attached to both surfaces 62, 64, as shown, for wicking and absorbing liquid ink with relative motion in either direction. As attached to the body portion 58 of the rigid scraping member 54, the liquid wicking and absorbing member 66 is suitable for immediately and quickly wicking and absorbing liquid ink scraped and wiped by the wiper blade(s) immediately after the cleaning blade 36 has wiped and cleaned the nozzle face of the printheads 28, thereby resulting in continued high quality printed images, and in a relatively longer printhead life.

In accordance with the present invention, the liquid wicking and absorbing member 66 preferably is made from a POREX material (POREX is a tradename of Porex Industries in Georgia USA). As gathered from disclosures by Porex Industries, porous plastic materials have membranes and intricate network of open-celled, omni-directional pores running through them. These pores, which can be made in average pore sizes down to one micron give porous plastic materials their unique combination of filtering and wicking capabilities, as well as structural strength.

Unlike direct passages in woven synthetic materials and metal screens, the pores in porous plastic materials join to form many tortuous paths. Porous plastic materials act both as surface filters by trapping particles larger than their average pore size, and also as depth filters by trapping much smaller particulate matter deep in their complex channels. When used as a wicking device the open-celled pore structure of these materials creates effective capillary channels for liquid transfer.

Porous plastic materials as such are used as marker tips, often called nibs, in a variety of writing instruments to wick ink from a reservoir to the writing surface. As such they function in capillary systems using inks having viscosity and surface tensions similar to that of water. Examples of such porous plastic materials are polyvinylidene fluoride (PVDF) or polyethylene (PE), depending on strength, ink flow, durability and shape considerations.

For increased absorbency, an additive (a surfactant) may be added to the PP or PE raw material in the process of making the resultant POREX porous plastic material suitable or liquid wicking and absorbing member 66 of the present invention.

As can be seen, there has been provided a cleaning blade cleaner assembly is provided for contacting, scraping, wiping and wicking residual liquid ink from a printhead cleaning blade immediately after the printhead cleaning blade has wiped and cleaned an ink jet printhead within an ink jet printer. The cleaning blade cleaner assembly includes a support frame and a rigid scraping member mounted to the support frame. The rigid scraping member has a body portion, and a scraping edge adjoining the body portion for making scraping and wiping contact with printhead cleaning blade during relative motion between the printhead cleaning blade and the rigid scraping member. The cleaning blade cleaner assembly also includes a liquid ink wicking and absorbing member attached to the body portion of the rigid scraping member for immediately and quickly wicking and absorbing liquid ink scraped and wiped from the printhead cleaning blade immediately after the printhead cleaning blade has wiped and cleaned an ink jet printhead within the ink jet printer, thereby resulting in continued high quality printed images, and in a relatively longer printhead life.

While the present invention has been described in conjunction with a specific embodiment thereof, it is evident that many alternatives, modifications, and variations will be apparent to those skilled in the art. Accordingly, it is intended to embrace all such alternatives, modifications and variations that fall within the spirit and broad scope of the appended claims.

We claim:

1. A cleaning blade cleaner assembly comprising:
(a) a support frame;
(b) a rigid scraping member mounted to said support frame, said rigid scraping member having a body portion, and a scraping edge adjoining said body portion for making scraping contact with a printhead wiper blade during relative motion between the printhead wiper blade and said rigid scraping member; and
(c) a liquid ink wicking and absorbing member attached to said body portion of said rigid scraping member for immediately and quickly wicking and absorbing liquid ink scraped and wiped by the printhead wiper blade, immediately after the printhead wiper blade has wiped and cleaned the nozzle face of a printhead, thereby resulting in continued high quality printed images and a relatively longer printhead life.

2. The cleaning blade cleaner assembly of claim 1, wherein said liquid ink wicking and absorbing material comprises a porous plastic material.

3. The cleaning blade cleaner assembly of claim 1, wherein said liquid ink wicking and absorbing member is mounted to one of a first, and a second and opposite, surfaces of said body portion.

4. The cleaning blade cleaner assembly of claim 1, wherein said liquid ink absorbing member is mounted to both of a first, and a second and opposite, surfaces of said body portion.

5. The cleaning blade cleaner assembly of claim 1, wherein said liquid ink absorbing member comprises a porous plastic material including a surfactant additive for increasing absorbency of said porous plastic material.

6. The cleaning blade cleaner assembly of claim 2, wherein said porous plastic material is made from polyethylene.

7. The cleaning blade cleaner assembly of claim 2, wherein said porous plastic material is made from polypropylene.

8. The cleaning blade cleaner assembly of claim 2, wherein said porous plastic material is made from polyvinylidene.

9. An ink jet printer for producing high quality images comprising:
(a) a support frame in part defining a sheet travel path;
(b) a sheet supply and handling assembly mounted to said frame for supplying and moving a sheet through said sheet travel path;
(c) a printhead having a nozzle face, said printhead being connected to an ink supply and located along said sheet travel path for printing ink images on the sheet moving through said sheet travel path; and
(d) a cleaning blade cleaner assembly including (i) a support frame; (ii) a rigid scraping member mounted to said support frame, said rigid scraping member having a body portion, and a scraping edge adjoining said body portion for making scraping contact with a printhead wiper blade during relative motion between the printhead wiper blade and said rigid scraping member; and (iii) a liquid ink wicking and absorbing member attached to said body portion of said rigid scraping member for immediately and quickly wicking and absorbing liquid ink scraped and wiped by the printhead wiper blade, immediately after the printhead wiper blade has wiped and cleaned the nozzle face of a printhead, thereby resulting in continued high quality printed images and a relatively longer printhead life.

10. The ink jet printer of claim 9, wherein said liquid ink wicking and absorbing material comprises a porous plastic material.

11. The ink jet printer of claim 9, wherein said liquid ink wicking and absorbing member is mounted to one of a first, and a second and opposite, surfaces of said body portion.

12. The ink jet printer of claim 9, wherein said liquid ink absorbing member is mounted to both of a first, and a second and opposite, surfaces of said body portion.
